(19) United States
(12) Patent Application Publication
(10) Pub. No.: US 2015/0094947 A1
(43) Pub. Date: Apr. 2, 2015

(54) PLACE DESCRIPTION INFORMATION ACQUISITION METHOD, AND TERMINAL

(71) Applicant: Tencent Technology (Shenzhen) Company Limited, Shenzhen (CN)

(72) Inventors: Yang LI, Shenzhen (CN); Zhanwei WANG, Shenzhen (CN)

(21) Appl. No.: 14/567,175

(22) Filed: Dec. 11, 2014

Related U.S. Application Data
(63) Continuation of application No. PCT/CN2013/076979, filed on Aug. 6, 2013.

(30) Foreign Application Priority Data
Jun. 11, 2012 (CN) 201210190817.0

(51) Int. Cl. G01C 21/34

(52) U.S. Cl. CPC G01C 21/3438
USPC 701/409

(57) ABSTRACT

Place description information acquisition method, terminal, server and system are provided. First location information of a first location where a first user is located and second location information of a second location where a second user is located are acquired. Third location information and place description information of selectable meeting places are acquired according to the first and second location information. The place description information is presented on a map of a city where the first user is located according to the third location information, so that the first user can select a meeting place from the selectable meeting places. The selected meeting place is close to the other user(s) to be met and/or between the user and the other user(s) to be met. As a result the acquired place description information is more pertinent, and the place description information can be acquired intellectually.

### CROSS REFERENCE TO RELATED APPLICATIONS

This application is a continuation of International Application No. PCT/CN2013/076979, filed on Jun. 8, 2013, which claims priority to Chinese Patent Application No. 201210190817.0, filed on Jun. 11, 2012, both of which are hereby incorporated by reference in their entireties.

### FIELD OF THE INVENTION

The present disclosure relates to the field of communications, particularly to a place description information acquisition method, terminal, server and system.

### BACKGROUND

With the rapid development of communication networks, lots of network based applications for communicating between people are available. For example, users can communicate with their friends through instant messaging tools. Users often meet friends at a selected place. A place description information acquisition method may help users to select quickly a meeting place by providing selectable meeting places and information associated with the meeting places and hence time spent on making choice can be saved.

Currently, users can use the Search Engine for providing searching service to find a meeting place. For example, users can enter a geographical scope to the Search Engine. The Search Engine will acquire place description information of dining places in the geographical scope. The description information may include the name, Cuisine information and/or average consumption of each of the dining places. The description information can be presented to the user so that the user may select a certain dining place as the meeting place according to the description information.

Users may generally enter a geographical scope for the meeting place to the Search Engine according to their locations, and the place description information of dining places is acquired according to the geographical scope. However, their friends may be far from the selected meeting place, that is to say, the acquired place description information is not pertinent. On the other hand, if users try to select a meeting place close to their friends, they generally don't know how to enter a geographical scope to acquire associated place description information unless they know about the geographical information of the areas where their friends live. Thereby, the traditional place description information acquisition method is not intelligent.

### SUMMARY OF THE INVENTION

The embodiments of the invention provide a place description information acquisition method, terminal, server and system, in order to facilitate the user to select a meeting place close to the user(s) to be met or between the user and the user(s) to be met.

In an aspect, a method for acquiring place description information is provided, comprising:

acquiring first location information of a first location where a first user is located and second location information of a second location where a second user to be met is located;

acquiring third location information and place description information of selectable meeting places according to the first location information and the second location information; and

presenting the place description information of the selectable meeting places on a map of a city where the first user is located according to the third location information of the selectable meeting places, so that the first user can select a meeting place from the selectable meeting places.

In another aspect, a method for acquiring place description information is provided, comprising:

receiving an acquisition request message with first location information of a first location where a first user is located and second location information of a second location where a second user to be met is located, from a terminal;

acquiring third location information and place description information of selectable meeting places according to the first location information and the second location information; and

sending an acquisition response message with the third location information and the place description information of the selectable meeting places to the terminal, so that the terminal can present the place description information of the selectable meeting places on a map of a city where the first user is located according to the third location information of the selectable meeting places.

In another aspect, a terminal is provided, comprising:

a first acquisition module for acquiring first location information of a first location where a first user is located and second location information of a second location where a second user to be met is located.

a second acquisition module for acquiring third location information and place description information of selectable meeting places according to the first location information and the second location information; and

a presentation module for presenting the place description information of the selectable meeting places on a map of a city where the first user is located according to the third location information of the selectable meeting places, so that the first user can select a meeting place from the selectable meeting places.

According to the embodiments, when a user wants to meet another user(s), first location information of a first location where the user is located and second location information of a second location where the other user to be met is located are acquired; location information and place description information of selectable meeting places are acquired according to the first location information and the second location information; and place description information of the selectable meeting places are presented on a map of a city where the user is located according to the location information of the selectable meeting places so that the user can select a meeting place from the selectable meeting places. Places close to the other user(s) to be met and/or places between the user and the other user(s) to be met can be acquired according to the first location information of the user and the second location information of the other user(s) to be met, and hence the user can select a meeting place from places close to the other user(s) to be met and/or places between the user and the other user(s) to be met. As a result the acquired place description information is more pertinent. On the other hand, even though the user does not know about the geographical information of the areas where the friends live, the method can still be implemented; that is to say, the place description information can be acquired intellectually.

### DESCRIPTION OF THE DRAWINGS

In order to more clearly illustrate the technical solutions of the present embodiments of the invention, description will be made below in combination with the drawings. Apparently, the drawings described below illustrate only some embodiments of the present invention. For the skill in the art, other embodiments are also conceivable according to these drawings.

FIG. 1 is a flowchart of a method for acquiring place description information according to an embodiment of the invention;

FIG. 2 is a flowchart of a method for acquiring place description information according to another embodiment of the invention;

FIG. 3 is an exemplary scenario where the method for acquiring place description information is applied according to a further embodiment of the invention;

FIG. 4 illustrates an interface of a smart phone according to a still further embodiment of the invention;

FIG. 5 is a flowchart of a method for acquiring place description information according to a still further embodiment of the invention;

FIG. 6 illustrates a structure of a terminal according to a still further embodiment of the invention;

FIG. 7 illustrates a structure of a place server according to a still further embodiment of the invention;

FIG. 8 illustrates a structure of a system for acquiring place description information according to a still further embodiment of the invention; and

FIG. 9 illustrates a structure of a terminal according to a still further embodiment of the invention.

### DETAILED DESCRIPTION

To clarify the purposes, solutions and advantages of the embodiments of the invention, the embodiments of the invention will be described in further detail in conjunction with the drawings.

### First Embodiment

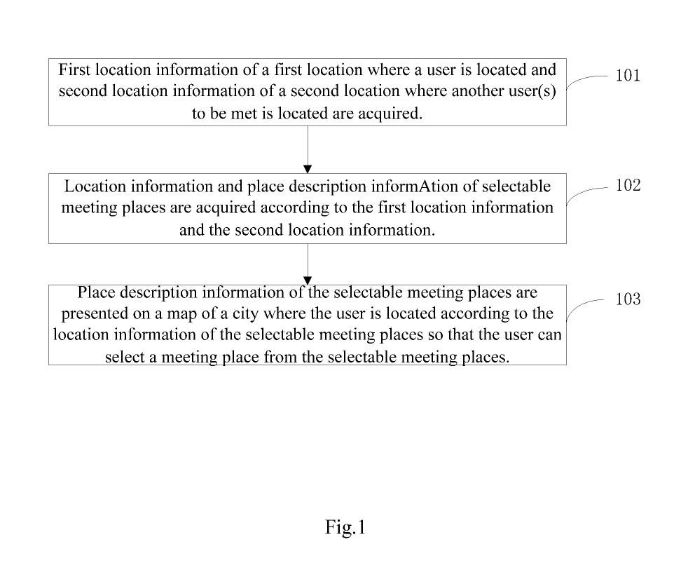

As shown in FIG. 1, an embodiment of the invention provides a method for acquiring place description information.

At step 101, first location information of a first location where a user is located and second location information of a second location where another user(s) to be met is located are acquired.

At step 102, location information and place description information of selectable meeting places are acquired according to the first location information and the second location information.

At step 103, place description information of the selectable meeting places are presented on a map of a city where the user is located according to the location information of the selectable meeting places so that the user can select a meeting place from the selectable meeting places.

The above method may be performed by a terminal.

According to the embodiment, when a user wants to meet another user(s), first location information of a first location where the user is located and second location information of a second location where the other user to be met is located are acquired; location information and place description information of selectable meeting places are acquired according to the first location information and the second location information; and place description information of the selectable meeting places are presented on a map of a city where the user is located according to the location information of the selectable meeting places so that the user can select a meeting place from the selectable meeting places. Places close to the other user(s) to be met and/or places between the user and the other user(s) to be met can be acquired according to the first location information of the user and the second location information of the other user(s) to be met, and hence the user can select a meeting place from places close to the other user(s) to be met and/or places between the user and the other user(s) to be met. As a result the acquired place description information is more pertinent. On the other hand, even though the user does not know about the geographical information of the areas where the friends live, the method provided by the embodiment can be implemented; that is to say, the place description information can be acquired intellectually.

### Second Embodiment

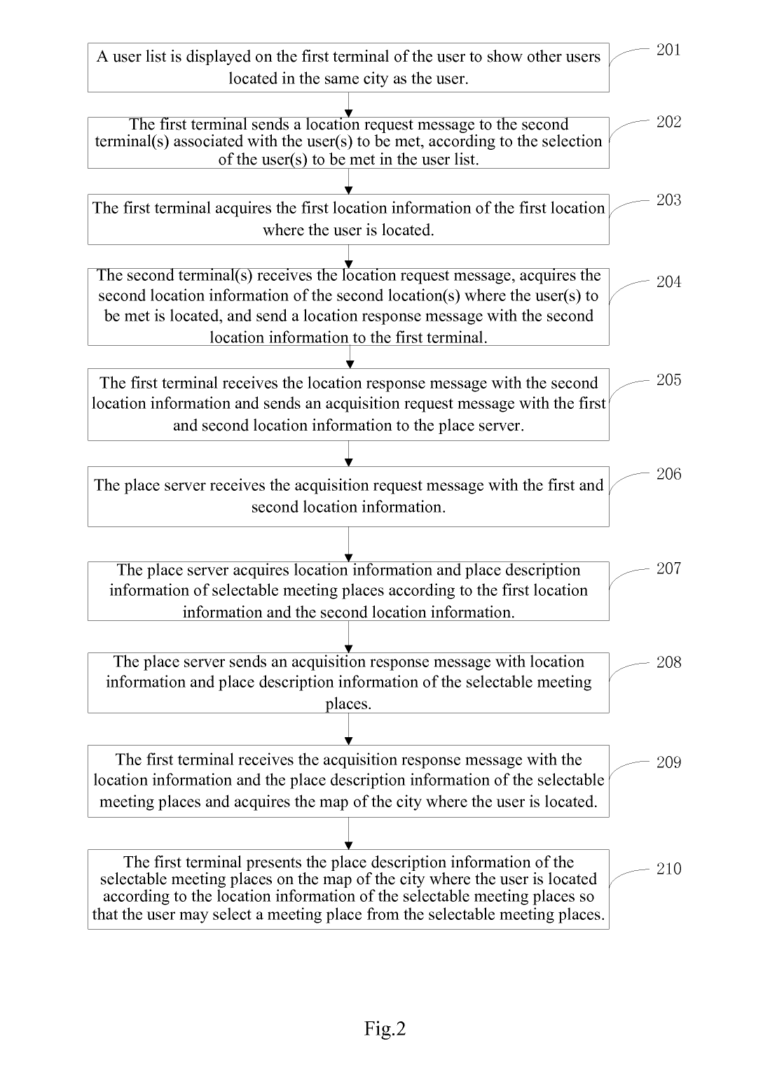

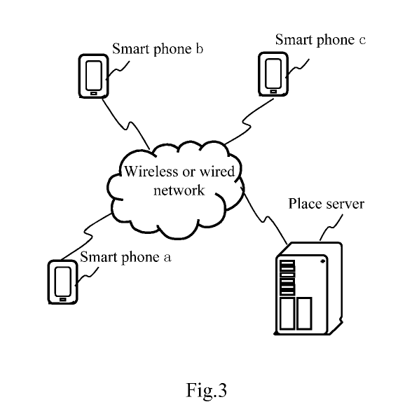

As shown in FIG. 2, the embodiment of the invention provides a method for acquiring place description information. FIG. 3 is an exemplary scenario where the method of the embodiment is applied. The scenario may include for example three smart phones with GPS modules and a place server. The smart phones can be connected to the place server via wireless connection or wired connection. The smart phone a with a GPS module is a first terminal used by a user A. The user A wants to meet two other users, i.e. user B and user C. A second terminal used by the user B is the smart phone b with a GPS module, and another second terminal used by the user C is the smart phone c with a GPS module. The method of the embodiments will be described in detail in the following.

At step 201, a user list is displayed on the first terminal of the user to show other users located in the same city as the user.

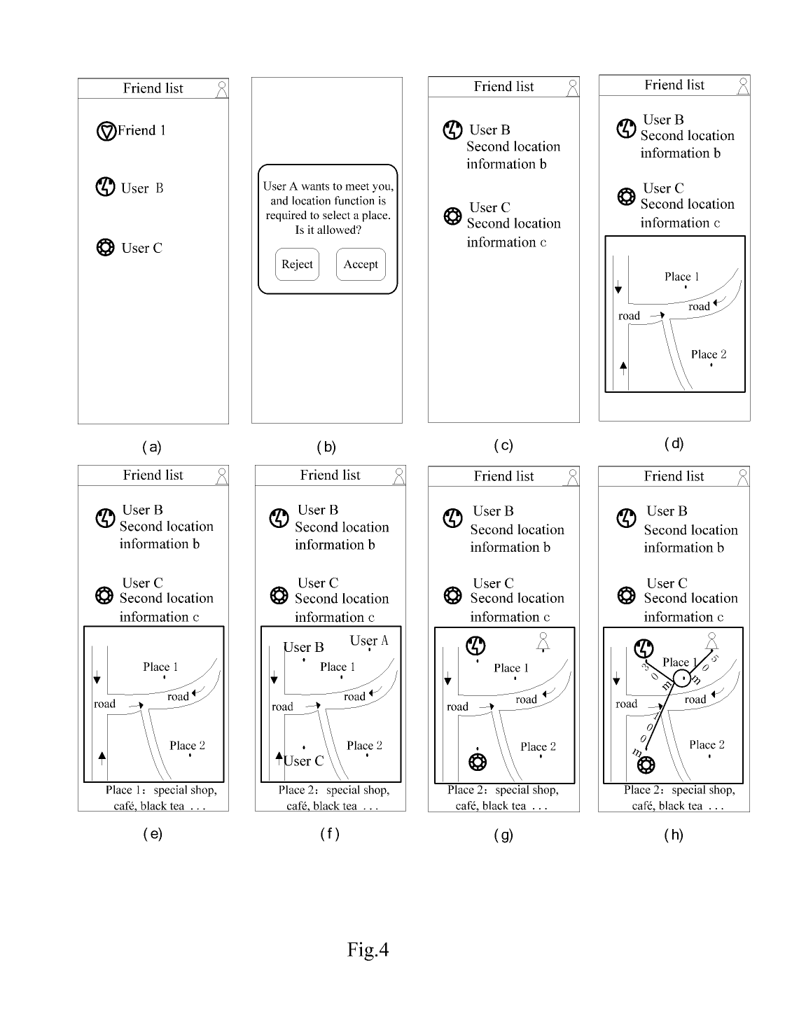

The user list (or friend list) may include identification information of other users in the same city as the user. The identification information may include, but not limited to, nicknames or head portrait of other users. When the user list is displayed on the first terminal, the user can select which user(s) to be met from the user list, and submit to the first terminal the selected user(s) to be met. For example, the user A may select user(s) to be met from the user list (as shown in FIG. 4a) displayed on the smart phone a and submit to the terminal the selected user(s) to be met.

At step 202, the first terminal sends a location request message to the second terminal(s) associated with the user(s) to be met, according to the selection of the user(s) to be met in the user list.

For example, the first terminal may acquire identification information of the user(s) to be met from the user list, according to the selection of the user(s) to be met in the user list. Then the first terminal sends the location request message to the second terminal(s) associated with the user(s) to be met according to the identification information of the user(s) to be met.

For example, if that the user A wants to meet the users B and C, the first terminal sends the location request message to the second terminal b associated with the user B and the second terminal c associated with the user C. That is to say, the smart phone a sends the location request message to the smart phone b associated with the user B and the smart phone c associated with the user C.

Optionally, in order to acquire place description information more quickly, a maximum of the amount of the users which may be selected from the user list may be set. If the amount is above the maximum, the first terminal may display prompt information so that the user may reselect which user(s) to be met. The maximum may be set for example through system settings of the first terminal.

For example, if the maximum is set to be five, the first terminal will display, for example, the words “you can select at most five users, and the amount of the users you select is above the maximum so please reselect users” when the user A selects the sixth user. Of course the first terminal may display any other prompt information as desired.

At step 203, the first terminal acquires the first location information of the first location where the user is located.

The first terminal may comprise a GPS module, for example. The first terminal may determine the location where the first terminal is located through the GPS module, to obtain the location information of the location which is the first location information of the first location where the user is located. Furthermore, the first terminal may acquire the first location information of the first location where the user is located through any other approach known by the skilled in the art.

The first location information may include, but not limited to, the latitude and longitude coordinates of the location where the first terminal is located.

The first terminal, for example, may determine the location where the first terminal is located, to obtain the first location information (xₐ, yₐ) of the first location where the user A is located. Alternatively, the first location information may be represented as (x₁, y₁), for example.

At step 204, the second terminal(s) receives the location request message, acquires the second location information of the second location(s) where the user(s) to be met is located, and send a location response message with the second location information to the first terminal.

The second terminal may comprise a GPS module, for example. After receiving the location request message, the second terminal may determine the location where the second terminal is located through the GPS module, to obtain the location information of the location where the second terminal is located. The obtained location information is the second location information of the second location(s) where the user(s) to be met is located. The second terminal may send the location response message with the second location information to the first terminal. Furthermore, the second terminal may acquire the second location information of the second location(s) where the user(s) to be met is located through any other approach known by the skilled in the art.

For example, the second location information may include, but not limited to, the latitude and longitude coordinates of the location where the second terminal is located.

For example, after receiving the location request message, the second terminal b associated with the user B to be met may determine the location where the second terminal b is located, to obtain location information (x_{b}, y_{b}) which is the second location information b of the second location b where the user B is located. The location response message with the second location information b (x_{b}, y_{b}) may be sent to the first terminal.

For example again, after receiving the location request message, the second terminal c associated with the user C to be met may determine the location where the second terminal c is located, to obtain location information (x_{c}, y_{c}) which is the second location information c of the second location c where the user C is located. The location response message with the second location information c (x_{c}, y_{c}) may be sent to the first terminal.

The parameter for the second location where the user B or C to be met is located may include, but not limited to, X. And the second location information may be also represented as (x₂, y₂), for example.

It should be noted that, at step 204, after receiving the location request message, the second terminal may display prompt information of the receipt of the location request message as shown in FIG. 4b so that the user associated with the second terminal may determine whether to respond to the received location request message. According to an embodiment of the invention, unless the user associated with the second terminal responds to the received location request message, the second terminal does not perform the processes of acquiring the second location information of the second location(s) and sending the location response message with the second location information to the first terminal. It should be noted that FIG. 4b shows only an example of the prompt information displayed by the second terminal.

At step 205, the first terminal receives the location response message with the second location information and sends an acquisition request message with the first and second location information to the place server.

For example, the first terminal receives the location response message with the second location information b (x_{b}, y_{b}) from the second terminal b and the location response message with the second location information c (x_{c}, y_{c}) from the second terminal c, and then the first terminal sends the acquisition request message with the first location information (xₐ, yₐ), the second location information b (x_{b}, y_{b}) and the second location information c (x_{c}, y_{c}) to the place server.

Optionally, after receiving the location response message with the second location information, the first terminal may display the second location information as identification information in the user list, as shown in FIG. 4c.

It should be noted that, if the user(s) associated with the second terminal(s) who has received the location request message decides not to respond to the received location request message at step 204, the first terminal can't receive the location response message with the second location information at step 205. In such case, for example, the first terminal may display prompt information so that the user may determine if the whole process should be ended. If the user determines the whole process should not be ended, then the process goes to step 201.

At step 206, the place server receives the acquisition request message with the first and second location information.

At step 207, the place server acquires location information and place description information of selectable meeting places according to the first location information and the second location information.

The step 207 may be performed for example by any of the following two methods.

Method 1

At step (1), the place server acquires, from a information table stored therein, location information and place description information of the places with first distances from the first location associated with the first location information, according to the first location information, and the place server arranges them into a place group, wherein the first distances are less than a predetermined distance.

The information table stored in the place server may include, but not limited to, location information and place description information of many places. The place description information may include, but not limited to, identification information of these places. The identification information may include, but not limited to, names of these places.

The place server may compute the first distance of each place in the information table from the first location associated with the first location information, according to the first location information and the location information of each place in the information table. Then the place server may select location information and place description information of the places in the information table with the first distances less than the predetermined distance; and the place server arranges them into a place group. The predetermined distance may be set for example, by an interface provided by the place server for setting the predetermined distance.

The places in the information table may include, but not limited to, recreational sites, such as restaurants, cafes and/or parks and so on. The place description information may include, but not limited to, identification information of the places. The identification information may include, but not limited to, names of the places. The place description information may further include other related information. For example, for cafes or restaurants, the related information may include cuisine information, average consumption, comment information and/or promotional discounts.

As shown in table 1, the information table includes location information and place description information. In particular, lines 3-5 of the table include respectively location information and place description information of place 1, place 2 and place 3.

TABLE 1

| | place description information | |
|---|---|---|
| location information | identification information | related information |
| (x₁, y₁) | Name 1 | Comments |
| (x₂, y₂) | Name 2 | None |
| (x₃, y₃) | Name 3 | Consumer Costs |
| . . . | . . . | . . . |

At step (2), the place server acquires, from the information table, location information and place description information of the places with second distances from the second location(s) associated with the second location information, according to the second location information, and the place server incorporates them into the place group, the second distances are less than the predetermined distance.

The place server may compute the second distance of each place in the information table from the second location(s) associated with the second location information, according to the second location information and the location information of each place in the information table. Then the place server may select location information and place description information of the places in the information table with the second distances less than the predetermined distance, and the place server incorporates them into the place group.

At step (3), selectable meeting places are selected from the group according to the first and second distances and their location information and place description information are determined.

The place server may compute a sum of the first and second distances of each place in the group. A predetermined number of places with smaller sum are selected as selectable meeting paces and their corresponding location information and place description information are determined. When the sum has a minimum value, the corresponding selectable meeting paces are located between the first location and the second location(s), which are preferable.

In addition, the invention does not intent to limit the method for selecting a predetermined number of places with smaller sum from the place group. For example, since the sum for the paces located between the first location and the second location(s) has a minimum value, these places are first selected. However, if the number of the places between the first location and the second location(s) is less than the predetermined number, other places with smaller sum are selected so that the predetermined number is met.

The predetermined number can be set, but not limited to, through an interface for setting predetermined number provided by the place server.

Furthermore, the selectable meeting places can be selected by any way known to the killed in the art.

Furthermore, the selectable meeting place may be selected and determined according to the related information of each place in the place group. For example, if the related information of a place in the place group includes information of promotional discounts, the place is selected as a selectable meeting place.

For example, when the place server receives, from the first terminal, the acquisition request message with the first location information (xₐ, yₐ), the second location information b (x_{b}, y_{b}) and the second location information c (x_{c}, y_{c}), the place server may compute the first distance La1 of the first location from place 1, according to the first location information (xₐ, yₐ) and the location information (x₁, y₁) of place 1, compute the first distance La2 of the first location from place 2, according to the first location information (xₐ, yₐ) and the location information (x₂, y₂) of place 2, and compute the first distance La3 of the first location from place 3, according to the first location information (xₐ, yₐ) and the location information (x₃, y₃) of place 3. If the first distances La1 and La2 are less than the predetermined distance, place 1 and place 2 are selected and arranged into a place group.

The place server may compute the second distance Lb1 of the second location b from place 1, according to the second location information b (x_{b}, y_{b}) and the location information (x₁, y₁) of place 1, compute the second distance Lb2 of the second location b from place 2, according to the second location information b (x_{b}, y_{b}) and the location information (x₂, y₂) of place 2, and compute the second distance Lb3 of the second location b from place 3, according to the second location information b (x_{b}, y_{b}) and the location information (x₃, y₃) of place 3. If the second distance Lb1 is less than the predetermined distance, place 1 is selected and added into the place group.

The place server may compute the second distance Lc1 of the second location c from place 1, according to the second location information c (x_{c}, y_{c}) and the location information (x₁, y₁) of place 1, compute the second distance Lc2 of the second location c from place 2, according to the second location information c (x_{c}, y_{c}) and the location information (x₂, y₂) of place 2, and compute the second distance Lc3 of the second location c from place 3, according to the second location information c (x_{c}, y_{c}) and the location information (x₃, y₃) of place 3. If the second distances Lc1 and Lc3 are less than the predetermined distance, places 1 and 3 are selected and added into the place group. Then the place group includes location information and place description information of place 1, place 2 and place 3.

The place server may compute the sum Labc1 of the distances for place 1 according to the first distance La1, the second distance Lb1 and the second distance Lc1, compute the sum Labc2 of the distances for place 2 according to the first distance La2, the second distance Lb2 and the second distance Lc2, and compute the sum Labc3 of the distances for place 3 according to the first distance La3, the second distance Lb3 and the second distance Lc3. If Labc1 is less than Labc2 and Labc2 is less than Labc3 and the predetermined number is 2, place 1 and place 2 are determined as the selectable meeting places and their location information and place description information are obtained.

Method 2

At step (a), a predetermined distance (i.e. predetermined threshold) is selected from a threshold set according to the first location information and the second location information. The selected predetermined distance is less than the distance between the first location and the second location but is above half of the distance between the first location and the second location.

For example, the distance between the first location and the second location may be computed according to the first location information and the second location information. The predetermined threshold may be selected from the threshold set including one or more predetermined thresholds. The selected predetermined threshold may be less than the distance between the first location and the second location but above half of the distance. However, if there is a plurality of predetermined thresholds in the threshold set which is less than the distance between the first location and the second location but above half of the distance, then one may be randomly selected from the plurality.

Alternatively, a predetermined threshold with a minimum value may be selected. The invention does not intend to limit the way for selecting the predetermined threshold.

A step (b), a first circular region is determined with the first location as its center and the selected predetermined threshold as its radius, and a second circular region is determined with the second location as its center and the selected predetermined threshold as its radius. Then an overlap region of the first region and the second region may be determined.

A step (c), location information and place description information of the places in the overlap region are acquired as location information and place description information of the selectable meeting places, from a stored information table including location information and place description information of lots of places.

If there is no place found in the overlap region, the predetermined threshold may be selected again, and the step (b) may be performed once more.

At step 208, the place server sends an acquisition response message with location information and place description information of the selectable meeting places.

Furthermore, the place server may acquire a map of the city where the user is located according to the first location and send the map to the first terminal.

For example, the place server may send an acquisition response message with location information and place description information of places 1 and 2.

At step 209, the first terminal receives the acquisition response message with the location information and the place description information of the selectable meeting places and acquires the map of the city where the user is located.

For example, if the place server sends the map of the city to the first terminal, the first terminal may use directly the map. If the map of the city has already been stored in the first terminal, the first terminal may load the map or replace the stored map with the received map from the place server.

At step 210, the first terminal presents the place description information of the selectable meeting places on the map of the city where the user is located according to the location information of the selectable meeting places so that the user may select a meeting place from the selectable meeting places.

For example, according to the location information of the selectable meeting places, the first terminal may determine the associated locations on the map. Presentation zones are provided on the associated locations and the place description information of the selectable meeting places are presented in the presentation zones.

For example, the first terminal may present the place description information of places 1 and 2 on the map according to the location information of places 1 and 2, as shown in FIG. 4(d).

Furthermore, the first terminal may present the identification information of the selectable meeting places in the presentation zones. When the user selects a certain one of the selectable meeting places, an information presentation zone is provided on the display screen of the first terminal. The whole place description information of the selected one of the selectable meeting places is presented in the information presentation zone. For example, the information presentation zone may be provided on the bottom of the display screen of the first terminal and the whole place description information of the selected one of the selectable meeting places is presented in the information presentation zone, as shown in FIG. 4 (e). The identification information of the meeting place may be presented in any other way known to the skilled in the art.

Furthermore, the first terminal may identify the first and second locations on the map according to the first and second location information, as shown in FIG. 4 (f).

Furthermore, the first terminal may provide a presentation zone on the first location associated with the first location information to present the head portrait or identification information of the user in the presentation zone or provide a presentation zone on the second location(s) associated with the second location information to present a head portrait or identification information of the user(s) to be met in the presentation zone, as shown in FIG. 4 (g).

Furthermore, when the user selects a certain one of the selectable meeting places, the first terminal may compute the distance between the first location and the selected meeting place according to the first location information associated with the first location and the location information of the selected meeting place and present the computed distance; and the first terminal may also compute the distance(s) between the second location(s) and the selected meeting place according to the second location information associated with the second location(s) and the location information of the selected meeting place and present the computed distance(s), as shown in FIG. 4 (h).

It should be noted that the invention does not intend to limit the order of the steps. For example, step 203 may be performed before or after step 202 or in parallel with step 202.

According to the embodiment, when a user wants to meet another user(s), first location information of a first location where the user is located and second location information of a second location where the other user to be met is located are acquired; location information and place description information of selectable meeting places are acquired according to the first location information and the second location information; the distances between the selectable meeting places and the first location are less than a predetermined distance, the distances between the selectable meeting places and the second location are less than the predetermined distance, and/or the selectable meeting places are located between the first location and the second location; the place description information of the selectable meeting places are presented on the map of the city according to the location information of the selectable meeting places. Since the distances between the selectable meeting places and the first location are less than the predetermined distance, the distances between the selectable meeting places and the second location are less than the predetermined distance, and/or the selectable meeting places are located between the first location and the second location, the user can select a meeting place which is close to the other user to be met and/or between the user and the other user to be met. As a result the acquired place description information is more pertinent. On the other hand, even though the user does not know about the geographical information of the areas where the friends live, the method provided by the embodiment can be implemented; that is to say, the place description information can be acquired intellectually.

### Third Embodiment

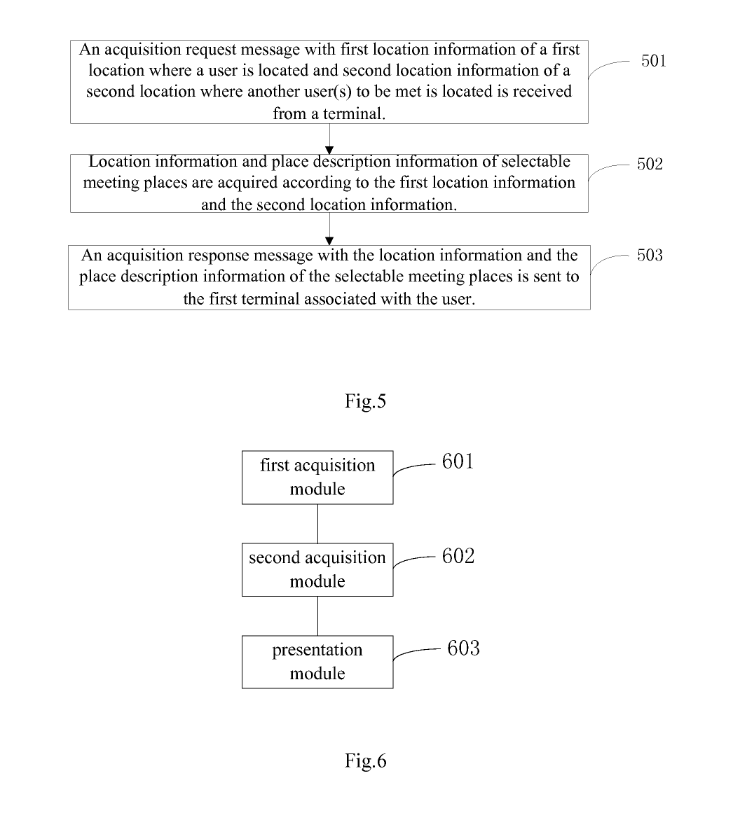

As shown in FIG. 5, an embodiment of the invention provides a method for acquiring place description information.

At step 501, an acquisition request message with first location information of a first location where a user is located and second location information of a second location where another user(s) to be met is located is received from a terminal.

At step 502, location information and place description information of selectable meeting places are acquired according to the first location information and the second location information.

At step 503, an acquisition response message with the location information and the place description information of the selectable meeting places is sent to the terminal, so that the terminal can present the place description information of the selectable meeting places on a map of a city where the user is located according to the location information of the selectable meeting places.

The above method may be performed by a place server.

According to the embodiment, the place server may receive an acquisition request message with first location information of a first location where a user is located and second location information of a second location where another user to be met is located, from a terminal; acquire location information and place description information of selectable meeting places according to the first location information and the second location information; and send an acquisition response message with the location information and the place description information of the selectable meeting places to the terminal, so that the terminal can present the place description information of the selectable meeting places on a map of a city where the user is located according to the location information of the selectable meeting places. And hence the user can select a meeting place from places close to the other user(s) to be met and/or places between the user and the other user(s) to be met. As a result the acquired place description information is more pertinent. On the other hand, even though the user does not know about the geographical information of the areas where the friends live, the method provided by the embodiment can be implemented; that is to say, the place description information can be acquired intellectually.

### Fourth Embodiment

As shown in FIG. 6, an embodiment of the invention provides a terminal. The terminal includes:

a first acquisition module 601 for acquiring first location information of a first location where a user is located and second location information of a second location where another user(s) to be met is located;

a second acquisition module 602 for acquiring location information and place description information of selectable meeting places according to the first location information and the second location information; and

a presentation module 603 for presenting the place description information of the selectable meeting places on a map of a city where the user is located according to the location information of the selectable meeting places, so that the user can select a meeting place from the selectable meeting places.

The first acquisition module 601 may include:

a location determination unit for determining the first location through a Global Position System (GPS) module included in a first terminal to obtain the first location information of the first location;

a first sending unit for sending a location request message to a second terminal associated with the other user to be met in order to determine the second location through a Global Position System (GPS) module included in the second terminal to obtain the second location information of the second location; and

a first receiving unit for receiving a location response message with the second location information from the second terminal.

The second acquisition module 602 may include:

a second sending unit for sending an acquisition request message with the first location information and the second location information to a place server, so that the place server provides the location information and the place description information of the selectable meeting places according to the first location information and the second location information; and

a second receiving unit for receiving an acquisition response message with the location information and the place description information of the selectable meeting places, from the place server.

The presentation module 603 may include:

a first determination unit for determining locations associated with the selectable meeting places on the map according to the location information of the selectable meeting places; and

a presentation unit for providing presentation zones on the associated location to present the place description information of the selectable meeting places in the presentation zones.

The presentation unit may provide presentation zones on the associated location to present identification information included in the place description information of the selectable meeting places in the presentation zones,

The presentation module 603 may further include:

a providing unit for, when the user selects one of the selectable meeting places, providing an information presentation zone to present the place description information of the selected one of the selectable meeting places in the information presentation zone.

According to the embodiment, the terminal may acquire first location information of a first location where a user is located and second location information of a second location where another user to be met is located; acquire location information and place description information of selectable meeting places according to the first location information and the second location information; and present the place description information of the selectable meeting places on a map of a city where the user is located according to the location information of the selectable meeting places, so that the user can select a meeting place from the selectable meeting places. And hence the user can select a meeting place from places close to the other user(s) to be met and/or places between the user and the other user(s) to be met. As a result the acquired place description information is more pertinent. On the other hand, even though the user does not know about the geographical information of the areas where the friends live, the method provided by the embodiment can be implemented; that is to say, the place description information can be acquired intellectually.

### Fifth Embodiment

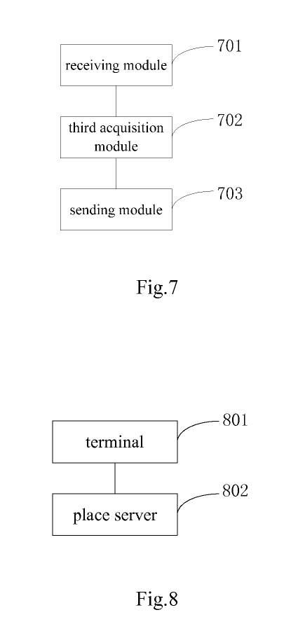

As shown in FIG. 7, an embodiment of the invention provides a place server. The place server includes:

a receiving module 701 for receiving an acquisition request message with first location information of a first location where a user is located and second location information of a second location where another user to be met is located, from a terminal;

a third acquisition module 702 for acquiring location information and place description information of selectable meeting places according to the first location information and the second location information; and

a sending module 703 for sending an acquisition response message with the location information and the place description information of the selectable meeting places to the terminal, so that the terminal can present the place description information of the selectable meeting places on a map of a city where the user is located according to the location information of the selectable meeting places.

The third acquisition module 702 may include:

an arrangement unit for acquiring, from a information table, location information and place description information of places with first distances from the first location less than a predetermined distance, according to the first location information, and arranging these places into a place group, wherein the information table comprises location information and place description information;

an incorporating unit for acquiring, from the information table, location information and place description information of places with second distances from the second location less than the predetermined distance, according to the second location information, and incorporating these places into the place group; and

a second determination unit for selecting the selectable meeting places from the place group according to the first and second distances and determining the location information and the place description information of the selectable meeting places.

The second determination unit may include:

a computation sub-unit for computing a sum of the first and second distances of each place in the place group; and

a determination sub-unit for selecting a predetermined number of places with smaller sums from the place group as the selectable meeting paces and determining the location information and the place description information of the selectable meeting places.

The third acquisition module 702 may include:

a selecting unit for selecting a predetermined threshold from a threshold set according to the first location information and the second location information, wherein the selected predetermined threshold is less than a distance between the first location and the second location but above half of the distance.

a third determination unit for determining a first circular region with the first location as its center and the selected predetermined threshold as its radius, a second circular region with the second location as its center and the selected predetermined threshold as its radius, and an overlap region of the first region and the second region;

a acquisition unit for acquiring location information and place description information of places in the overlap region as the location information and the place description information of the selectable meeting places, from a information table including location information and place description information.

According to the embodiment, the place server may receive an acquisition request message with first location information of a first location where a user is located and second location information of a second location where another user to be met is located, from a terminal; acquire location information and place description information of selectable meeting places according to the first location information and the second location information; and send an acquisition response message with the location information and the place description information of the selectable meeting places to the terminal, so that the terminal can present the place description information of the selectable meeting places on a map of a city where the user is located according to the location information of the selectable meeting places. And hence the user can select a meeting place from places close to the other user(s) to be met and/or places between the user and the other user(s) to be met. As a result the acquired place description information is more pertinent. On the other hand, even though the user does not know about the geographical information of the areas where the friends live, the method provided by the embodiment can be implemented; that is to say, the place description information can be acquired intellectually.

### Sixth Embodiment

As shown in FIG. 8, an embodiment of the invention provides a system for acquiring place description information, comprising the terminal 801 as described in the fourth embodiment and the place server 802 as described in the fifth embodiment.

According to the embodiment, when a user wants to meet another user(s), first location information of a first location where the user is located and second location information of a second location where the other user to be met is located are acquired; location information and place description information of selectable meeting places are acquired according to the first location information and the second location information; and place description information of the selectable meeting places are presented on a map of a city where the user is located according to the location information of the selectable meeting places so that the user can select a meeting place from the selectable meeting places. Places close to the other user(s) to be met and/or places between the user and the other user(s) to be met can be acquired according to the first location information of the user and the second location information of the other user(s) to be met, and hence the user can select a meeting place from places close to the other user(s) to be met and/or places between the user and the other user(s) to be met. As a result the acquired place description information is more pertinent. On the other hand, even though the user does not know about the geographical information of the areas where the friends live, the method provided by the embodiment can be implemented; that is to say, the place description information can be acquired intellectually.

### Seventh Embodiment

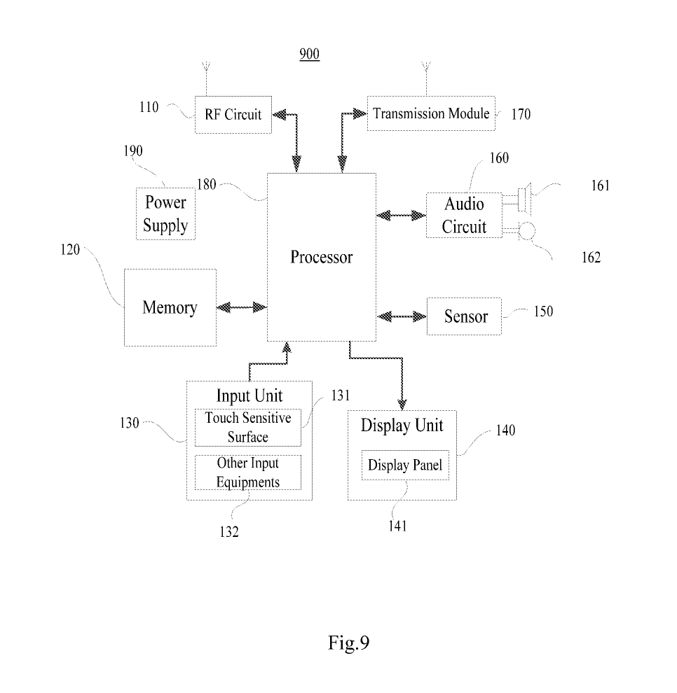

As shown in FIG. 9, an embodiment of the invention provides a terminal. FIG. 9 illustrates a structure of the terminal with a touch sensitive surface according to an embodiment of the invention. And the terminal may perform the method of the above embodiments.

In particular, the terminal 900 may include a RF (radio frequency) circuit 110, a memory 120 including one or more computer-readable storage media, an input unit 130, a display unit 140, a sensor 150, an audio circuit 160, a transmission module 170, a processor including one or more processing cores, a power supply 190 and so on. Those skilled in the art may understand that the structure of the terminal as shown in FIG. 9 is not intended to define the terminal, and that the terminal equipment may include more or less components than those shown in FIG. 9, some of which may be combined together or arranged differently.

The RF circuit 110 may be used to receive or send signals during receiving or sending a message or making a call. In particular, it receives downlink information from a base station, and the received information is then processed by one or more processors 180; additionally, the RF circuit 110 sends data related to uplink to the base station. Generally, the RF circuit 110 includes but not limited to an antenna, at least one amplifier, a tuner, one or more oscillators, a subscriber identity module (SIM), a transceiver, a coupler, a low noise amplifier (LNA), a duplexer and so forth. Further, the RF circuit 110 may communicate with other equipments via wireless communication or network. The wireless communication may use any communication standards or protocols including but not limited to Global System of Mobile communication (GSM), General Packet Radio Service (GPRS), Code Division Multiple Access (CDMA), Wideband Code Division Multiple Access (WCDMA), Long Term Evolution (LTE), email, Short Messaging Service (SMS), etc.

The memory 120 may be used to store software programs and modules, such as those used by the terminal, place server and system for acquiring place description information as described in embodiments 4-6. The processor 180 performs a variety of function application and data processing by operating the software programs and modules stored in the memory 120. The memory 120 may mainly include an area for storing programs and an area for storing data; wherein the area for storing programs may store an operating system and an application program required by at least one function (such as, an audio play function and a video play function), and so on; the area for storing data may store data created according to the usage of the terminal 900 (such as, audio data, a telephone book), and so on. Additionally, the memory 120 may include a high speed random access memory and a non-volatile memory (such as, at least one magnetic disk storage device, a flash storage device, or other non-volatile solid storage devices). Correspondingly, the memory 120 may also include a memory controller to provide access to the memory 120 for the processor 180 and the input unit 130.

The input unit 130 may be used to receive the input data or character information, and generate signals input by a keyboard, a mouse, an action bar, an optical input equipment or a trackball. Particularly, the input unit 130 may include a touch sensitive surface 131 and other input equipments 132. The touch sensitive surface 131, also called a touch display screen or a touch pad, may collect the user's touch operations thereon or nearby (for example, operations on or round the touch sensitive surface 131 by the user using a finger or a touch pen), and drive corresponding connecting device according to a preset program. Optionally, the touch sensitive surface 131 may include both a touch detecting device and a touch controller. The touch detecting device detects the user's touch location and signal caused by the touch operation, and communicates the signal to the touch controller; the touch controller receives the touch information from the touch detecting device, transforms the received information into touch point coordinates, and then transfers the touch point coordinates to the processor 180, and the touch controller may also receive commands sent from the processor 180 and then perform the commands. Additionally, the touch sensitive surface 131 may be implemented in variety types, such as, resistance-type, capacitance-type, infrared, surface acoustic wave (SAW), and so on. In addition to the touch sensitive surface 131, the input unit 130 may also include other input equipments 132. Particularly, other input equipments 132 may include but not limited to one or more of a physical keyboard, a function key (e.g., a audio control key, a switch key etc.), a trackball, a mouse, a action bar, and so on.

The display unit 140 may be used to information entered by the user or information provided to the user, and a variety of Graphical User Interfaces (GUI) (which may be composed of graphics, texts, icons, videos or any combination of them) of the terminal 900. The display unit 140 may include a display panel 141. Optionally, the display panel 141 may be configured as a Liquid Crystal Display (LCD), an Organic Light-Emitting Diode (OLED) etc. Furthermore, the touch sensitive surface 131 may cover the display panel 141. When the touch sensitive surface 131 detects the touch operations thereon or nearby, it will transfer the touch operations to the controller 180 to determine a type of the touch event; and the controller 180 then provides corresponding visual output on the display panel 141 according to the type of the touch event. Although, the touch sensitive surface 131 and the display panel 141 are two independent components to respectively implement input function and output function as shown in FIG. 9, in some embodiments, the touch sensitive surface 131 and the display panel 141 may be integrated together to implement both the input function and the output function.

The terminal 900 may also include at least one sensor 150, such as, a light sensor, a motion sensor and other sensors. Particularly, the light sensor may include an ambient light sensor and a proximity sensor. Wherein the ambient light sensor may adjust brightness of the display panel 141 according to intensity of the ambient light; the proximity sensor may turn off the display panel 141 and/or backlight, when the terminal 900 moves close to the user's ear. A gravity acceleration sensor, as a kind of motion sensor, may detect magnitude of the acceleration in each direction (generally three-axis). When the terminal 900 is static, the gravity acceleration sensor may detect magnitude and direction of the gravity. The gravity acceleration sensor may be used in applications for indentifying gestures of the mobile phone (such as, a switch between a landscape mode and a portrait mode, related games and a magnetometer calibration), and functions related to vibration recognition (such as, a pedometer and a knocking function) etc. The terminal 900 may also be configured with a gyroscope, a barometer, a hygrometer, a thermometer, an infrared sensor and other sensors, which will not be described here.

An audio circuit 160, a loudspeaker 161 and a microphone 162 may provide an audio interface between the user and the terminal 900. The audio circuit 160 may receive audio data, transform the received audio data into electrical signals, and transmit the electrical signals to the loudspeaker 161; the loudspeaker 161 may transform the electrical signals into sound signals for output; on the other hand, the microphone 162 may transform the received sound signals into electrical signals; the audio circuit 160 may receive the electrical signals, transform them into audio data, and output the audio data to the processor 180 for processing; the processed audio data may be sent to another terminal or the memory 120 for further processing via the RF circuit 110. The audio circuit 160 may further include an earplug jack to provide communications between peripheral earphones with the terminal 900.

The terminal 900 may help the user to receive and send emails, browse webpage and access streaming media via the transmission module 170. The transmission module 170 provides a wireless wideband Internet access for the user. Although the transmission module 170 has been shown in FIG. 9, it may be understood that the transmission module 170 is not a necessary component of the terminal 900, which may be omitted as appropriate and without departing from the scope of essence of the application.

The processor 180 is a control center for the terminal 900. The processor 180 connects each part of the whole terminal using a variety of interfaces and lines. The processor 180 performs a variety of functions of the terminal 900 and processes data, by operating or performing the software programs and/or modules stored in the memory 120 and invoking data stored in the memory 120, so as to monitor the whole terminal. Optionally, the processor 180 may include one or more processing cores. In certain embodiments, an application processor and a modem processor may be integrated into the processor 180. Wherein the application processor mainly processes operating systems, user interfaces and application programs, etc.; the modem processor mainly processes wireless communications. It should be understood that the modem processor may do not be integrated into the processor 180.

The terminal 900 may also include a power supply 190 (such as, a battery) to supply power to each component. In certain embodiments, the power supply may be logically connected with the processor 180 via a power management system, so that functions, such as, Charge, discharge, and power consumption management, may be managed by the power management system. The power supply 190 may further include one or more AC or DC power supplies, a recharging system, a power failure detection circuit, a power converter or inverter, a power status indicator, and any other components.

The terminal 900 may also include a camera and a Bluetooth module (not shown), which will not be described here. In the embodiment, the display unit of the terminal is a touch screen display. The terminal includes a memory and one or more programs. Wherein the one or more programs are stored in the memory and configured to contain instructions to be performed by one or more processors to conduct the following operations:

acquiring first location information of a first location where a user is located and second location information of a second location where another user to be met is located;

acquiring location information and place description information of selectable meeting places according to the first location information and the second location information; and

presenting the place description information of the selectable meeting places on a map of a city where the user is located according to the location information of the selectable meeting places, so that the user can select a meeting place from the selectable meeting places.

The above may be the first implementation. According to a second implementation based on the first implementation, the memory of the terminal may include further instructions to conduct the following operations:

determining the first location through a Global Position System (GPS) module included in a first terminal to obtain the first location information of the first location;

sending a location request message to a second terminal associated with the other user to be met in order to determine the second location through a Global Position System (GPS) module included in the second terminal to obtain the second location information of the second location; and

receiving a location response message with the second location information from the second terminal.

According to a third implementation based on the first implementation, the memory of the terminal may include further instructions to conduct the following operations:

sending an acquisition request message with the first location information and the second location information to a place server, so that the place server provides the location information and the place description information of the selectable meeting places according to the first location information and the second location information; and

receiving an acquisition response message with the location information and the place description information of the selectable meeting places, from the place server.

According to a fourth implementation based on the first implementation, the memory of the terminal may include further instructions to conduct the following operations:

determining locations associated with the selectable meeting places on the map according to the location information of the selectable meeting places; and

providing presentation zones on the associated location to present the place description information of the selectable meeting places in the presentation zones.

According to a fifth implementation based on the fourth implementation, the memory of the terminal may include further instructions to conduct the operation of presenting identification information included in the place description information of the selectable meeting places in the presentation zones, and

the following operation conducted after the operation of presenting the place description information of the selectable meeting places in the presentation zones:

when the user selects one of the selectable meeting places, providing an information presentation zone to present the place description information of the selected one of the selectable meeting places in the information presentation zone.

According to a sixth implementation based on any one of the first to fifth implementations, the memory of the terminal may include further instructions to conduct the operation of identifying the first location and the second location on the map according to the first location information and the second location information, and

the following operation conducted after the operation of presenting the place description information of the selectable meeting places on a map of a city where the user is located:

when the user selects one of the selectable meeting places, computing and presenting a distance between the first location and the selected one of the selectable meeting places according to the first location information and the location information of the selected one of the selectable meeting places, and computing and presenting a distance between the second location and the selected one of the selectable meeting places according to the second location information and the location information of the selected one of the selectable meeting places.

According to the terminal of the embodiment, first location information of a first location where the user is located and second location information of a second location where the other user to be met is located are acquired; location information and place description information of selectable meeting places are acquired according to the first location information and the second location information; the distances between the selectable meeting places and the first location are less than a predetermined distance, the distances between the selectable meeting places and the second location are less than the predetermined distance, and/or the selectable meeting places are located between the first location and the second location; the place description information of the selectable meeting places are presented on the map of the city according to the location information of the selectable meeting places. Since the distances between the selectable meeting places and the first location are less than the predetermined distance, the distances between the selectable meeting places and the second location are less than the predetermined distance, and/or the selectable meeting places are located between the first location and the second location, the user can select a meeting place which is close to the other user to be met and/or between the user and the other user to be met. As a result the acquired place description information is more pertinent. On the other hand, even though the user does not know about the geographical information of the areas where the friends live, the method provided by the embodiment can be implemented; that is to say, the place description information can be acquired intellectually.

### Eighth Embodiment

The embodiment provides a computer readable storage medium. The computer readable storage medium can be included in the memory described above or independent from the terminal described above. The computer readable storage medium can store one or more programs. The one or more programs can be executed by one or more processors to perform a method, comprising:

acquiring first location information of a first location where a user is located and second location information of a second location where another user to be met is located;

acquiring location information and place description information of selectable meeting places according to the first location information and the second location information; and

presenting the place description information of the selectable meeting places on a map of a city where the user is located according to the location information of the selectable meeting places, so that the user can select a meeting place from the selectable meeting places.

The above may be the first implementation. According to a second implementation based on the first implementation, the memory of the terminal may include further instructions to conduct the following operations:

determining the first location through a Global Position System (GPS) module included in a first terminal to obtain the first location information of the first location;

sending a location request message to a second terminal associated with the other user to be met in order to determine the second location through a Global Position System (GPS) module included in the second terminal to obtain the second location information of the second location; and

receiving a location response message with the second location information from the second terminal.

According to a third implementation based on the first implementation, the memory of the terminal may include further instructions to conduct the following operations:

sending an acquisition request message with the first location information and the second location information to a place server, so that the place server provides the location information and the place description information of the selectable meeting places according to the first location information and the second location information; and

receiving an acquisition response message with the location information and the place description information of the selectable meeting places, from the place server.

According to a fourth implementation based on the first implementation, the memory of the terminal may include further instructions to conduct the following operations:

determining locations associated with the selectable meeting places on the map according to the location information of the selectable meeting places; and

providing presentation zones on the associated location to present the place description information of the selectable meeting places in the presentation zones.

According to a fifth implementation based on the fourth implementation, the memory of the terminal may include further instructions to conduct the operation of presenting identification information included in the place description information of the selectable meeting places in the presentation zones, and

the following operation conducted after the operation of presenting the place description information of the selectable meeting places in the presentation zones:

when the user selects one of the selectable meeting places, providing an information presentation zone to present the place description information of the selected one of the selectable meeting places in the information presentation zone.

According to a sixth implementation based on any one of the first to fifth implementations, the memory of the terminal may include further instructions to conduct the operation of identifying the first location and the second location on the map according to the first location information and the second location information, and

the following operation conducted after the operation of presenting the place description information of the selectable meeting places on a map of a city where the user is located:

when the user selects one of the selectable meeting places, computing and presenting a distance between the first location and the selected one of the selectable meeting places according to the first location information and the location information of the selected one of the selectable meeting places, and computing and presenting a distance between the second location and the selected one of the selectable meeting places according to the second location information and the location information of the selected one of the selectable meeting places.

According to the computer readable storage medium of the embodiment, first location information of a first location where the user is located and second location information of a second location where the other user to be met is located are acquired; location information and place description information of selectable meeting places are acquired according to the first location information and the second location information; the distances between the selectable meeting places and the first location are less than a predetermined distance, the distances between the selectable meeting places and the second location are less than the predetermined distance, and/or the selectable meeting places are located between the first location and the second location; the place description information of the selectable meeting places are presented on the map of the city according to the location information of the selectable meeting places. Since the distances between the selectable meeting places and the first location are less than the predetermined distance, the distances between the selectable meeting places and the second location are less than the predetermined distance, and/or the selectable meeting places are located between the first location and the second location, the user can select a meeting place which is close to the other user to be met and/or between the user and the other user to be met. As a result the acquired place description information is more pertinent. On the other hand, even though the user does not know about the geographical information of the areas where the friends live, the method provided by the embodiment can be implemented; that is to say, the place description information can be acquired intellectually.

### Ninth Embodiment

The embodiment provides a graphical user interface on a terminal. The terminal may includes, for example, a touch display screen, a memory and one or more processors for executing one or more programs. The graphical user interface comprises:

acquiring first location information of a first location where a user is located and second location information of a second location where another user to be met is located;

acquiring location information and place description information of selectable meeting places according to the first location information and the second location information; and

presenting the place description information of the selectable meeting places on a map of a city where the user is located according to the location information of the selectable meeting places, so that the user can select a meeting place from the selectable meeting places.

According to the graphical user interface of the embodiment, first location information of a first location where the user is located and second location information of a second location where the other user to be met is located are acquired; location information and place description information of selectable meeting places are acquired according to the first location information and the second location information; the distances between the selectable meeting places and the first location are less than a predetermined distance, the distances between the selectable meeting places and the second location are less than the predetermined distance, and/or the selectable meeting places are located between the first location and the second location; the place description information of the selectable meeting places are presented on the map of the city according to the location information of the selectable meeting places. Since the distances between the selectable meeting places and the first location are less than the predetermined distance, the distances between the selectable meeting places and the second location are less than the predetermined distance, and/or the selectable meeting places are located between the first location and the second location, the user can select a meeting place which is close to the other user to be met and/or between the user and the other user to be met. As a result the acquired place description information is more pertinent. On the other hand, even though the user does not know about the geographical information of the areas where the friends live, the method provided by the embodiment can be implemented; that is to say, the place description information can be acquired intellectually.

What should be noted is that: when acquiring place description information, the terminal and place server provided by the above embodiments take the above function modules as examples for illustration. In the practical application, the above functions may be assigned to different modules as required, i.e., the internal structure of the terminal and place server may be divided into different function modules to implement all or a part of the functions. Additionally, the terminal, place server and system provided by the above embodiments belong to the same conception as the method for acquiring place description information, detailed implementations of which may refer to the method embodiments and is thus omitted.

Those skilled in the art may understand that all or a part of the steps of the above embodiments may be implemented by hardware, or be implemented by program instruction related hardware. All the programs may be stored in a computer readable storage medium, such as, a read-only memory, a magnetic disk or an optical disk, etc.

The above described embodiments are merely preferred embodiments of the invention, but not intended to limit the invention. Any modifications, equivalent alternations and improvements that are made within the spirit and scope of the invention should be included in the protection scope of the invention.

What is claimed is:

1. A method for acquiring place description information, comprising:
acquiring first location information of a first location where a first user is located and second location information of a second location where a second user to be met is located;
acquiring third location information and place description information of selectable meeting places according to the first location information and the second location information; and
presenting the place description information of the selectable meeting places on a map of a city where the first user is located according to the third location information of the selectable meeting places, so that the first user can select a meeting place from the selectable meeting places.

2. The method of claim 1, wherein acquiring the first location information and the second location information comprises:
determining the first location through a Global Position System (GPS) module included in a first terminal associated with the first user to obtain the first location information;
sending, by the first terminal, a location request message to a second terminal associated with the second user in order to determine the second location through a Global Position System (GPS) module included in the second terminal to obtain the second location information; and
receiving, by the first terminal, a location response message with the second location information from the second terminal.

3. The method of claim 1, wherein acquiring third location information and place description information of selectable meeting places comprises:
sending an acquisition request message with the first location information and the second location information to a place server, so that the place server provides the third location information and the place description information of the selectable meeting places according to the first location information and the second location information; and
receiving an acquisition response message with the third location information and the place description information of the selectable meeting places, from the place server.

4. The method of claim 1, wherein presenting the place description information of the selectable meeting places on a map comprises:
determining locations associated with the selectable meeting places on the map according to the third location information of the selectable meeting places; and
providing presentation zones on the associated locations to present the place description information of the selectable meeting places in the presentation zones.

5. The method of claim 4, wherein presenting the place description information of the selectable meeting places in the presentation zones comprises:
presenting identification information included in the place description information in the presentation zones, and
wherein, when the first user selects one of the selectable meeting places, providing an information presentation zone to present the place description information of the selected one of the selectable meeting places in the information presentation zone.

6. The method of claim 1, further comprising:
identifying the first location and the second location on the map according to the first location information and the second location information, and
when the first user selects one of the selectable meeting places, computing and presenting a distance between the first location and the selected one of the selectable meeting places according to the first location information and the location information of the selected one of the selectable meeting places, and computing and presenting a distance between the second location and the selected one of the selectable meeting places according to the second location information and the location information of the selected one of the selectable meeting places.

7. A method for acquiring place description information, comprising:
receiving an acquisition request message with first location information of a first location where a first user is located and second location information of a second location where a second user to be met is located, from a terminal;
acquiring third location information and place description information of selectable meeting places according to the first location information and the second location information; and
sending an acquisition response message with the third location information and the place description information of the selectable meeting places to the terminal, so that the terminal can present the place description information of the selectable meeting places on a map of a city where the first user is located according to the third location information of the selectable meeting places.

8. The method of claim 7, wherein acquiring third location information and place description information of selectable meeting places comprises:
acquiring, from a information table, location information and place description information of places with first distances from the first location less than a predetermined distance, according to the first location information, and arranging these places into a place group;
acquiring, from the information table, location information and place description information of places with second distances from the second location less than the predetermined distance, according to the second location information, and incorporating these places into the place group; and
selecting the selectable meeting places from the place group according to the first and second distances and determining the location information and the place description information of the selectable meeting places.

9. The method of claim 8, wherein selecting the selectable meeting places and determining the location information comprises:
computing a sum of the first and second distances of each place in the place group; and
selecting a predetermined number of places with smaller sums from the place group as the selectable meeting paces.

10. The method of claim 7, wherein acquiring the third location information and the place description information of the selectable meeting places comprises:
selecting a predetermined threshold from a threshold set according to the first location information and the second location information, wherein the selected predetermined threshold is less than a distance between the first location and the second location but above half of the distance;
determining a first circular region with the first location as its center and the selected predetermined threshold as its radius, a second circular region with the second location as its center and the selected predetermined threshold as its radius, and an overlap region of the first region and the second region;
acquiring location information and place description information of places in the overlap region as the location information and the place description information of the selectable meeting places, from a information table.

11. A terminal, comprising:
a first acquisition module for acquiring first location information of a first location where a first user is located and second location information of a second location where a second user to be met is located;
a second acquisition module for acquiring third location information and place description information of selectable meeting places according to the first location information and the second location information; and
a presentation module for presenting the place description information of the selectable meeting places on a map of a city where the first user is located according to the third location information of the selectable meeting places, so that the first user can select a meeting place from the selectable meeting places.

12. The terminal of claim 11, wherein the first acquisition module comprises:
a location determination unit for determining the first location through a Global Position System (GPS) module included in the terminal to obtain the first location information of the first location, wherein the terminal is associated with the first user;
a first sending unit for sending a location request message to a second terminal associated with the second user in order to determine the second location through a Global Position System (GPS) module included in the second terminal to obtain the second location information; and
a first receiving unit for receiving a location response message with the second location information from the second terminal.

13. The terminal of claim 11, wherein the second acquisition module comprises:
a second sending unit for sending an acquisition request message with the first location information and the second location information to a place server, so that the place server provides the third location information and the place description information of the selectable meeting places according to the first location information and the second location information; and
a second receiving unit for receiving an acquisition response message with the third location information and the place description information of the selectable meeting places, from the place server.

14. The terminal of claim 11, wherein the presentation module comprises:
a first determination unit for determining locations associated with the selectable meeting places on the map according to the third location information of the selectable meeting places; and
a presentation unit for providing presentation zones on the associated locations to present the place description information of the selectable meeting places in the presentation zones.

15. The terminal of claim 14, wherein the presentation unit presents identification information included in the place description information in the presentation zones, wherein the presentation module further comprises:
a providing unit for, when the first user selects one of the selectable meeting places, providing an information presentation zone to present the place description information of the selected one of the selectable meeting places in the information presentation zone.

16. The terminal of claim 11, wherein the terminal further comprises:
an identification module for identifying the first location and the second location on the map according to the first location information and the second location information, and
a computation and presentation module for, when the first user selects one of the selectable meeting places, computing and presenting a distance between the first location and the selected one of the selectable meeting places according to the first location information and the location information of the selected one of the selectable meeting places, and computing and presenting a distance between the second location and the selected one of the selectable meeting places according to the second location information and the location information of the selected one of the selectable meeting places.
